(19) United States
(12) Patent Application Publication
(10) Pub. No.: US 2026/0084480 A1
(43) Pub. Date: Mar. 26, 2026

(54) MOVABLE OBJECT INCLUDING WHEEL AND METHOD OF OPERATING THE SAME

(71) Applicants: Hyundai Motor Company, Seoul (KR); Kia Corporation, Seoul (KR)

(72) Inventors: Eun Ho Seo, Hwaseong-si (KR); Hyeon Sik Shin, Hwaseong-si (KR); Dae Keun Yoon, Hwaseong-si (KR)

(21) Appl. No.: 19/089,303

(22) Filed: Mar. 25, 2025

(30) Foreign Application Priority Data
Sep. 25, 2024 (KR) 10-2024-0130222

(51) Int. Cl. B60G 21/02

(52) U.S. Cl. CPC B60G 21/023; B60G 2500/30

(57) ABSTRACT

In a method of operating a movable object, in which the movable object includes two or more wheels at least spaced apart from one another in a forward/rearward direction, and two or more eccentric drive parts are each respectively configured to connect a wheel and the body part, the two or more eccentric drive parts can be controlled so that an angle defined between the body part and a ground surface is minimized in a range in which the second side is positioned within the rotatable angle by which the second side is rotatable about the first side.

### CROSS-REFERENCE TO RELATED APPLICATIONS

This application claims priority to and the benefit of Korean Patent Application No. 10-2024-0130222 filed in the Korean Intellectual Property Office on September 25, 2024, the entire contents of which are incorporated herein by reference.

### TECHNICAL FIELD

The present disclosure relates to a movable object including wheels and a method of operating the same.

### BACKGROUND

For an eccentric drive device configured to change a relative position between a wheel and a mobility vehicle body provided in a mobility vehicle, the mobility vehicle may advantageously operate in a state in which a motion of the mobility vehicle body is minimized on non-flat terrain by operating the eccentric drive device.

With the increasing demand for mobility vehicles, there is also a growing need for configurations that efficiently control the mobility vehicles to meet the purposes thereof. For example, in case that the mobility vehicle is used to transport items, the mobility vehicle body, onto which the items are loaded, needs to travel while maintaining a state in which the mobility vehicle is positioned as parallelly as possible with respect to a ground surface regardless of a state of the ground surface.

### SUMMARY

An embodiment of the present disclosure can allow a mobility vehicle to travel while maintaining a state in which a mobility vehicle body, which constitutes a body of the mobility vehicle, can be positioned as parallelly as possible with respect to a ground surface regardless of a state of the ground surface.

To achieve the above-mentioned advantages, an embodiment of the present disclosure can provide a movable object including: a body part; wheels provided at one side of the body part; and eccentric drive parts, each configured to connect the wheel and the body part and configured to change a relative position between the wheel and the body part, in which the eccentric drive part can include a connection member having a first side rotatably coupled to the wheel, and a second side rotatably coupled to the body part, and in which the eccentric drive part can operate so that a rotatable angle by which the second side is rotatable about the first side can be restricted within a predetermined or selected range.

The eccentric drive part may operate so that the rotatable angle by which the second side is rotatable about the first side is smaller than 180 degrees.

The eccentric drive part may operate so that the second side is always positioned inward of the first side based on a forward/rearward direction of the movable object.

To achieve the above-mentioned advantages, an embodiment of the present disclosure can provide a method of operating the movable object, in which the movable object includes: two or more wheels at least spaced apart from one another in a forward/rearward direction; and two or more eccentric drive parts, each configured to connect the wheel and the body part, and in which the two or more eccentric drive parts can be controlled so that an angle defined between the body part and a ground surface can be minimized in a range in which the second side is positioned within the rotatable angle by which the second side is rotatable about the first side.

The rotatable angle by which the second side is rotatable about the first side of the connection member of each of the eccentric drive parts may be set to be smaller than 180 degrees.

The second side of the connection member of each of the eccentric drive parts may be always positioned outward of the first side based on a forward/rearward direction of the movable object.

A method embodiment of the present disclosure may include: a first target setting operation of setting a target height of the body part with respect to the ground surface and a target angle of the body part with respect to the ground surface; and a first determination operation of determining, based on the first target setting operation, whether the second side of the connection member of each of the eccentric drive parts is positioned within the rotatable angle by which the second side is rotatable about the first side.

In the first determination operation, based on the target setting operation, whether the second side of the connection member of each of the eccentric drive parts is positioned within the rotatable angle by which the second side is rotatable about the first side may be determined in a state in which the body part is kept parallel to the ground surface.

A method embodiment of the present disclosure may further include: a body part posture adjustment operation of adjusting a height of the body part in an upward/downward direction when it is determined in the first determination operation that the second side of each of at least some of the connection members of the eccentric drive parts deviates from the rotatable angle by which the second side is rotatable about the first side.

The body part posture adjustment operation may include lowering the body part to decrease the height of the body part in the upward/downward direction in i) a state in which the body part is parallel to the ground surface and ii) a state in which the second side of the connection member, which is determined as deviating from an upper boundary, is positioned on the upper boundary of the rotatable angle when it is determined in the first determination operation that the connection member, which has the second side determined as deviating from the rotatable angle by which the second side is rotatable about the first side, deviates from the upper boundary of two opposite boundaries in the upward/downward direction of the rotatable angle.

The body part posture adjustment operation may include raising the body part to increase the height of the body part in the upward/downward direction in i) a state in which the body part is parallel to the ground surface and ii) a state in which the second side of the connection member, which is determined as deviating from a lower boundary, is positioned on the lower boundary of the rotatable angle when it is determined in the first determination operation that the connection member, which has the second side determined as deviating from the rotatable angle by which the second side is rotatable about the first side, deviates from the lower boundary of two opposite boundaries in the upward/downward direction of the rotatable angle.

The body part posture adjustment operation may include inclining the body part to adjust the height of the body part while inclining the body part so that the body part has a predetermined or selected angle with respect to the ground surface when it is determined in the first determination operation that the connection members of some of the eccentric drive parts deviate from an upper boundary of two opposite boundaries in the upward/downward direction of the rotatable angle and the connection members of some of the other eccentric drive parts deviate from a lower boundary of the two opposite boundaries in the upward/downward direction of the rotatable angle.

The inclining of the body part may adjust the height of the body part in i) a state in which the second side of the connection member, which is determined as deviating from the upper boundary in the first determination operation, is positioned on the upper boundary of the rotatable angle and ii) a state in which the second side of the connection member, which is determined as deviating from the lower boundary in the first determination operation, is positioned on the lower boundary of the rotatable angle when it is determined in the first determination operation that the connection members of some of the eccentric drive parts deviate from the upper boundary of the two opposite boundaries in the upward/downward direction of the rotatable angle and the connection members of some of the other eccentric drive parts deviate from the lower boundary of the two opposite boundaries in the upward/downward direction of the rotatable angle.

The inclining of the body part may derive an angle defined between the body part and the ground surface from a relationship formula between i) a height of the second side of each of the connection members provided in the movable object, ii) a height of the body part, and iii) the angle defined between the body part and the ground surface and inclines the body part while corresponding to the derived angle.

The inclining of the body part may derive the angle of the body part with respect to the ground surface from the relationship formula by use of a pseudo inverse.

According to an embodiment of the present disclosure, a mobility vehicle may travel while maintaining the state in which the mobility vehicle body, which constitutes the body of the mobility vehicle, can be positioned as parallelly as possible with respect to the ground surface regardless of a state of the ground surface.

### BRIEF DESCRIPTION OF THE DRAWINGS

FIG. 1 is a side view illustrating a movable object according to an embodiment of the present disclosure and illustrating a state made before the movable object passes over a low obstacle.

FIG. 2 is a side view illustrating a state in which the movable object in FIG. 1 passes over the low obstacle.

FIG. 3 is a side view illustrating a movable object according to an embodiment of the present disclosure and illustrating an initial state in which the movable object passes over a high obstacle.

FIG. 4 is a side view illustrating a latter state in which the movable object in FIG. 3 passes over the high obstacle.

FIG. 5 is an enlarged side view illustrating a state in which a connection member of the movable object according to an embodiment of the present disclosure is coupled to a body part and a wheel.

FIG. 6 is a flowchart illustrating a method of operating the movable object according to an embodiment of the present disclosure.

### DETAILED DESCRIPTION OF ILLUSTRATIVE EMBODIMENTS

Hereinafter, a movable object and a method of operating the same according to example embodiments of the present disclosure will be described with reference to the drawings.

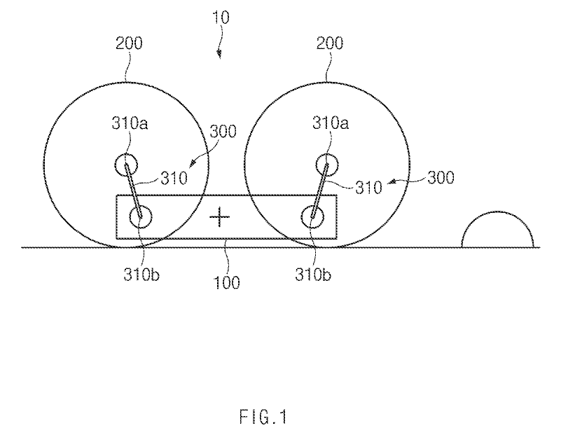

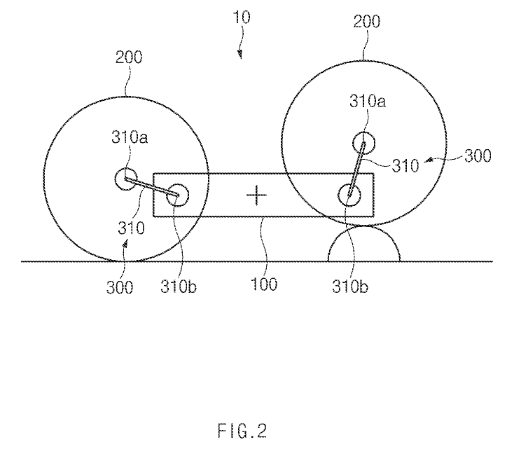

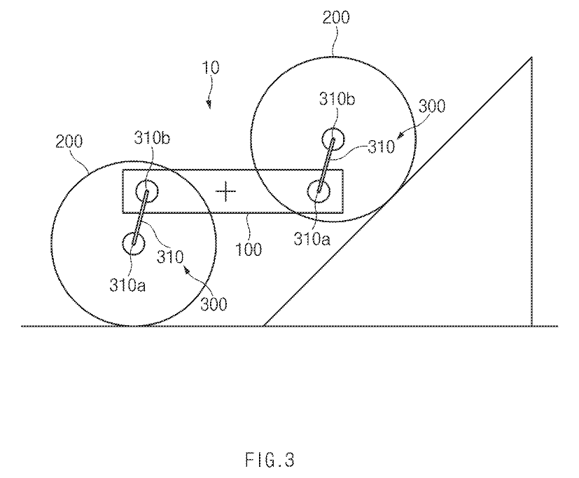

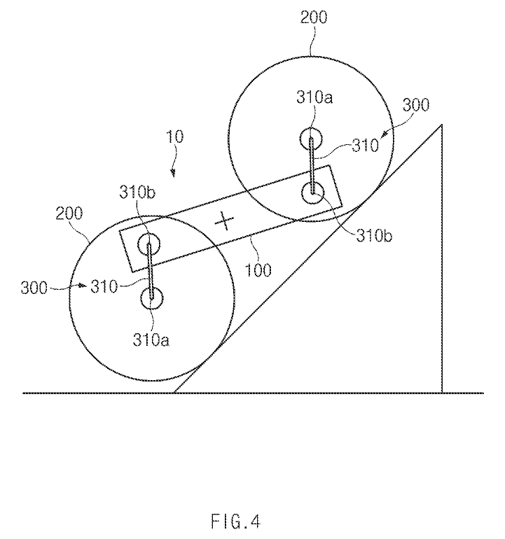

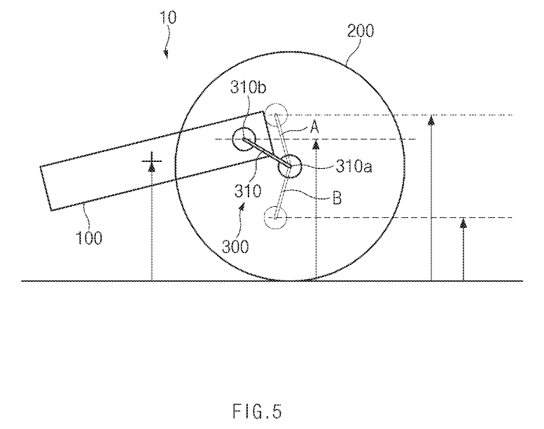

FIG. 1 is a side view illustrating a movable object according to an embodiment of the present disclosure and illustrating a state made before the movable object passes over a low obstacle. FIG. 2 is a side view illustrating a state in which the movable object in FIG. 1 passes over the low obstacle. FIG. 3 is a side view illustrating a movable object according to an embodiment of the present disclosure and illustrating an initial state in which the movable object passes over a high obstacle. FIG. 4 is a side view illustrating a latter state in which the movable object in FIG. 3 passes over the high obstacle. FIG. 5 is an enlarged side view illustrating a state in which a connection member of the movable object according to an embodiment of the present disclosure is coupled to a body part and a wheel.

A movable object 10 according to an embodiment of the present disclosure may include: a body part 100 configured to define a body of the movable object; wheels 200 provided at one side of the body part 100; and eccentric drive parts 300, each configured to connect a wheel 200 and the body part 100 and configured to change a relative position between the wheel 200 and the body part 100. FIGS. 1 to 5 illustrate example embodiments in which the wheels 200 are respectively provided in front and rear regions of the body part 100, such that the two wheels 200 can be spaced apart from each other in a forward/rearward direction. However, for example, the movable object 10 according to an embodiment of the present disclosure may include four wheels 200 (e.g., two wheels on each side of the body part 100). In such case, the two wheels 200 may be respectively provided at left and right sides of the front region of the body part 100, and the remaining two wheels 200 may be respectively provided at left and right sides of the rear region of the body part 100, for example.

The eccentric drive part 300 may include a connection member 310 having a first side 310a rotatably coupled to the wheel 200, and a second side 310b rotatably coupled to the body part 100. According to an embodiment of the present disclosure, when the second side 310b relatively rotates about the first side 310a, an angle of the connection member 310 with respect to a ground surface may be changed, such that a relative position between the wheel 200 and the body part 100 may be changed.

In such case, according to an embodiment of the present disclosure, the above-mentioned eccentric drive part 300 may operate so that a rotatable angle by which the second side 310b is rotatable about the first side 310a can be restricted within a predetermined or selected range. The above-mentioned predetermined or selected range may be a preset range. That is, according to an embodiment of the present disclosure, the connection member 310 may be configured to not rotate infinitely. For example, the eccentric drive part 300 may operate so that the rotatable angle by which the second side 310b is rotatable about the first side 310a is smaller than 180 degrees, and the second side 310b can be always positioned inward of the first side 310a based on a forward/rearward direction of the movable object 10. This can be to always apply a supporting force of the ground surface to the wheel 200 during an operating process of the eccentric drive part 300 regardless of the relative position of the connection member 310. More specifically, in the case of the connection member 310 connected to the wheel 200 provided in the front region of the body part 100 among the plurality of wheels 200, the second side 310b may be always positioned rearward of the first side 310a. In the case of the connection member 310 connected to the wheel 200 provided in the rear region of the body part 100 among the plurality of wheels 200, the second side 310b may be always positioned forward of the first side 310a.

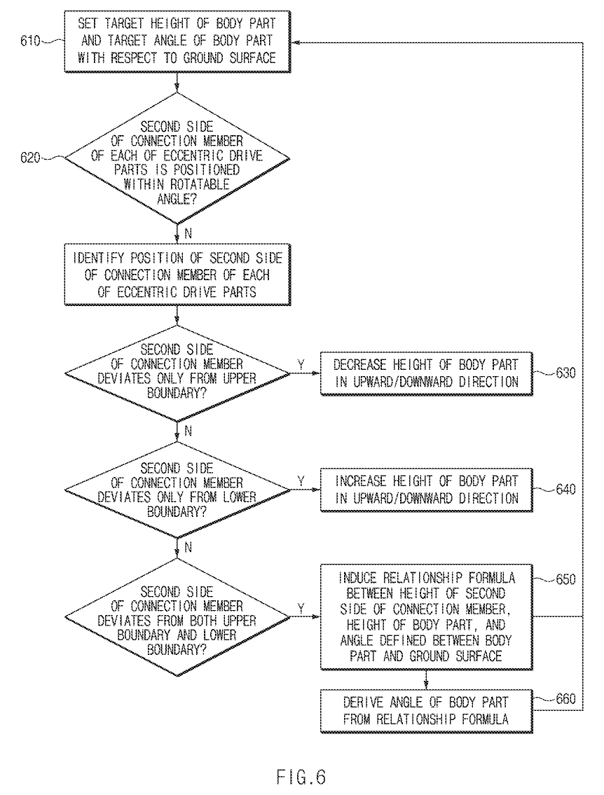

FIG. 6 is a flowchart illustrating a method of operating a movable object according an embodiment of to the present disclosure.

In a method of operating the movable object 10 according to an embodiment of the present disclosure, the movable object 10 may include two or more wheels 200 at least spaced apart from one another in the forward/rearward direction, and two or more eccentric drive parts 300 configured to connect the wheels 200 and the body part 100 (see, e.g., FIGS. 1-5). For example, the movable object 10 may include two wheels provided in the front region of the body part 100, and two wheels provided in the rear region of the body part 100.

In a method of operating the movable object 10 according to an embodiment of the present disclosure, the two or more eccentric drive parts 300 may be controlled so that an angle defined between the body part 100 and the ground surface can be minimized within a range in which the second side 310b is positioned within the rotatable angle by which the second side 310b is rotatable about the first side 310a. In particular, in a method of operating the movable object according to an embodiment of the present disclosure, the rotatable angle by which the second side 310b is rotatable about the first side 310a of the connection member 310 of the eccentric drive part 300 may be set to be smaller than 180 degrees, and the movable object may be operated so that the second side 310b of the connection member 310 of the eccentric drive part 300 can be always positioned inward of the first side 310a based on the forward/rearward direction of the movable object 10.

With reference to FIG. 6, the method of operating the movable object according an embodiment of to the present disclosure may include a first target setting operation of setting a target height of the body part 100 with respect to the ground surface and setting a target angle of the body part 100 with respect to the ground surface (operation 610). The above-mentioned first target setting operation may be performed in a case that the movable object meets an obstacle positioned forward of the movable object, and the movable object needs to pass over the obstacle during an operating process of the movable object.

A method of operating the movable object according to an embodiment of the present disclosure may further include a first determination operation of determining, based on the first target setting operation, whether the second side 310b of each of the connection members 310 of the eccentric drive parts 300 of the movable object is positioned within the rotatable angle by which the second side 310b is rotatable about the first side 310a. More specifically, in the first determination operation, whether the second side 310b of each of the connection members 310 of the eccentric drive parts 300 is positioned within the rotatable angle by which the second side 310b is rotatable about the first side 310a may be determined (operation 620), based on the first target setting operation, in a state in which the body part 100 is kept parallel to the ground surface.

A method of operating the movable object according to an embodiment of the present disclosure may further include a body part posture adjustment operation of adjusting a height of the body part 100 in an upward/downward direction (i.e., a relative height with respect to the ground surface) when it is determined in first determination operation that the second side 310b of each of at least some of the connection members 310 of the eccentric drive parts 300 deviates from the rotatable angle by which the second side 310b is rotatable about the first side 310a.

The case, in which the second side 310b of the connection member 310 of the eccentric drive part 300 of the movable object 10 deviates from the rotatable angle, may be broadly classified into: i) a case in which the second side 310b deviates from an upper boundary A (see FIG. 5) of two opposite boundaries in the upward/downward direction of the rotatable angle, and ii) a case in which the second side 310b deviates from a lower boundary B (see FIG. 5) of the two opposite boundaries in the upward/downward direction of the rotatable angle.

In such case, according to an embodiment of the present disclosure, the body part posture adjustment operation may include lowering the body part to decrease the height of the body part 100 in the upward/downward direction (operation 630), and raising the body part to increase the height of the body part 100 in the upward/downward direction (operation 640). More specifically, the body part posture adjustment operation may include the lowering of the body part to decrease the height of the body part 100 in the upward/downward direction (operation 630) in i) a state in which the body part 100 is parallel to the ground surface and ii) a state in which the second side 310b of the connection member 310, which can be determined as deviating from the upper boundary A, is positioned on the upper boundary A of the rotatable angle in a case that it is determined in the above-mentioned first determination operation that the connection member 310, which has the second side 310b determined as deviating from the rotatable angle by which the second side 310b is rotatable about the first side 310a, deviates from the upper boundary A of the two opposite boundaries in the upward/downward direction of the rotatable angle.

The body part posture adjustment operation may further include the raising of the body part to increase the height of the body part 100 in the upward/downward direction (operation 640) in i) a state in which the body part 100 is parallel to the ground surface and ii) a state in which the second side 310b of the connection member 310, which is determined as deviating from the lower boundary B, is positioned on the lower boundary B of the rotatable angle in case that it is determined in the above-mentioned first determination operation that the connection member 310, which has the second side 310b determined as deviating from the rotatable angle by which the second side 310b is rotatable about the first side 310a, deviates from the lower boundary B of the two opposite boundaries in the upward/downward direction of the rotatable angle.

More specifically, as illustrated in FIG. 1, in a case that an obstacle is present forward of the movable object 10 in a state in which the second side 310b of the connection member 310 connected to the wheel 200 provided at the front side of the movable object 10 is positioned in the vicinity of the lower boundary B (see FIG. 5), the wheel 200 provided at the front side can be raised above the obstacle, as illustrated in FIG. 2. In such case, according to an embodiment of the present disclosure, in the above-mentioned first determination operation, the second side 310b can be determined as deviating from the lower boundary B (see FIG. 5). Therefore, in the body part posture adjustment operation, the raising of the body part can be performed as described above. In such case, the raising of the body part may be performed by adjusting the position of the second side 310b of the connection member 310 connected to the wheel 200 provided at the rear side.

In the above-mentioned first determination operation, in a case that the second sides 310b of the plurality of connection members 310 are determined as deviating from the rotatable angle, the second sides 310b of some of the connection member 310 may be determined as deviating from the upper boundary A, whereas the second sides 310b of some of the other connection members 310 may be determined as deviating from the lower boundary B. In such case, the method may further include inclining the body part 100 so that the body part 100 has a predetermined or selected angle with respect to the ground surface so that the body part 100 according to an embodiment of the present disclosure is not parallel to the ground surface.

More specifically, according to an embodiment of the present disclosure, the body part posture adjustment operation may further include the inclining of the body part to adjust the height of the body part 100 while inclining the body part 100 so that the body part 100 has a predetermined or selected angle with respect to the ground surface in a case that it is determined in the above-mentioned first determination operation that the connection members 310 of some of the eccentric drive parts 300 deviate from the upper boundary A of the two opposite boundaries in the upward/downward direction of the rotatable angle, and the connection members 310 of some of the other eccentric drive parts 300 deviate from the lower boundary B of the two opposite boundaries in the upward/downward direction of the rotatable angle. The inclining of the body part may be performed in a case that the body part 100 cannot pass over the obstacle, which can be disposed forward of the movable object 10, any further in the state in which the body part 100 is kept parallel to the ground surface.

More specifically, the above-mentioned inclining of the body part may adjust the height of the body part 100 in i) a state in which the second side 310b of the connection member 310, which is determined as deviating from the upper boundary A in the first determination operation, is positioned on the upper boundary A of the rotatable angle and ii) a state in which the second side 310b of the connection member 310, which is determined as deviating from the lower boundary B in the first determination operation, is positioned on the lower boundary B of the rotatable angle in case that it is determined in the above-mentioned first determination operation that the connection members of some of the eccentric drive parts deviate from the upper boundary of the two opposite boundaries in the upward/downward direction of the rotatable angle, and the connection members of some of the other eccentric drive parts deviate from the lower boundary of the two opposite boundaries in the upward/downward direction of the rotatable angle.

More specifically, as illustrated in FIG. 4, the body part 100 can be inclined in a case that the body part 100 needs to pass over the obstacle in a state in which the second side 310b of the connection member 310 connected to the wheel 200 provided at the front side of the movable object 10 is positioned on the lower boundary B (see FIG. 5) and the second side 310b of the connection member 310 connected to the wheel 200 provided at the rear side of the movable object 10 is positioned on the upper boundary A (see FIG. 5) during the process in which the movable object 10 passes over the obstacle disposed forward of the movable object 10, as illustrated in FIG. 3. That is, according to an embodiment of the present disclosure, it can be that the body part 100 cannot be kept parallel to the ground surface any further in the above-mentioned situation. Even in such case, according to an embodiment of the present disclosure, the movable object may operate so that the angle of the body part 100 with respect to the ground surface can be minimized even in a case that the body part 100 is inclined. That is, based on FIG. 4, according to an embodiment of the present disclosure, in the above-mentioned inclining of the body part, the body part 100 can be inclined in a state in which the second side 310b of the connection member 310 connected to the wheel 200 provided at the front side is positioned on the lower boundary B and the second side 310b of the connection member 310 connected to the wheel 200 provided at the rear side is positioned on the upper boundary A. Therefore, the body part may be inclined in the state in which the angle defined between the body part 100 and the ground surface is minimized.

The above-mentioned inclining of the body part may derive the angle defined between the body part 100 and the ground surface from a relationship formula between i) a height of the second side 310b of each of the connection members 310 provided in the movable object 10, ii) a height of the body part 100, and iii) the angle defined between the body part 100 and the ground surface (operations 650 and 660), and incline the body part 100 while corresponding to the derived angle. For example, the above-mentioned inclining of the body part may derive the angle of the body part 100 with respect to the ground surface from the relationship formula by use of a pseudo inverse.

Example embodiments of the present disclosure has been described with reference to the drawings, but the present disclosure is not necessarily limited thereby. Embodiments of the present disclosure may be carried out in various forms by those skilled in the art, to which the present disclosure pertains, within the technical spirit of the present disclosure and the scopes equivalent to the appended claims.

What is claimed is:

1. A movable object comprising:
a body part;
wheels provided at one side of the body part; and
eccentric drive parts, wherein each of the eccentric drive parts is configured to connect a given wheel of the wheels and the body part and wherein each of the eccentric drive parts is configured to change a relative position between the given wheel and the body part,
wherein each of the eccentric drive parts comprises a connection member having a first side rotatably coupled to the given wheel, and having a second side rotatably coupled to the body part; and
wherein each of the eccentric drive parts is configured to operate so that a rotatable angle by which the second side is rotatable about the first side is restricted within a selected range.

2. The movable object of claim 1, wherein each of the eccentric drive parts is configured to operate so that the rotatable angle by which the second side is rotatable about the first side is smaller than 180 degrees.

3. The movable object of claim 1, wherein each of the eccentric drive parts is configured to operate so that the second side is always positioned inward of the first side based on a forward/rearward direction of the movable object.

4. A method of operating a movable object that comprises a body part,
a plurality of wheels spaced apart from one another in a forward/rearward direction, and a plurality of eccentric drive parts, each eccentric drive part being configured to connect an associated wheel and the body part, wherein each of the eccentric drive parts comprises a connection member having a first side rotatably coupled to the given wheel and having a second side rotatably coupled to the body part, the method comprising:
controlling the eccentric drive parts to change a relative position between the associated wheel and the body part so that an angle defined between the body part and a ground surface is minimized in a range in which the second side is positioned within a rotatable angle by which the second side is rotatable about the first side, the rotatable angle being restricted within a selected range.

5. The method of claim 4, further comprising setting the rotatable angle by which the second side is rotatable about the first side of the connection member of each of the eccentric drive parts to be smaller than 180 degrees.

6. The method of claim 4, further comprising limiting a position of the second side of the connection member of each of the eccentric drive parts to be always positioned outward of the first side based on a forward/rearward direction of the movable object.

7. The method of claim 4, comprising:
performing a first target setting operation, wherein the first target setting operation comprises setting a target height of the body part with respect to the ground surface and setting a target angle of the body part with respect to the ground surface; and
performing a first determination operation of determining, based on the first target setting operation, whether the second side of the connection member of each of the eccentric drive parts is positioned within the rotatable angle by which the second side is rotatable about the first side.

8. The method of claim 7, wherein in the first determination operation, based on the setting of the target angle, determining whether the second side of the connection member of each of the eccentric drive parts is positioned within the rotatable angle by which the second side is rotatable about the first side in a state in which the body part is kept parallel to the ground surface.

9. The method of claim 7, further comprising:
a body part posture adjustment operation of adjusting a height of the body part in an upward/downward direction based on determining in the first determination operation that the second side of each of at least some of the connection members of the eccentric drive parts deviates from the rotatable angle by which the second side is rotatable about the first side.

10. The method of claim 9, wherein the body part posture adjustment operation comprises lowering the body part to decrease the height of the body part in the upward/downward direction in a state in which the body part is parallel to the ground surface and in the state in which the second side of the connection member, which is determined as deviating from an upper boundary, is positioned on the upper boundary of the rotatable angle based on determining in the first determination operation that the connection member, which has the second side determined as deviating from the rotatable angle by which the second side is rotatable about the first side, deviates from the upper boundary of two opposite boundaries in the upward/downward direction of the rotatable angle.

11. The method of claim 9, wherein the body part posture adjustment operation comprises raising the body part to increase the height of the body part in the upward/downward direction in a state in which the body part is parallel to the ground surface and in the state in which the second side of the connection member, which is determined as deviating from a lower boundary, is positioned on the lower boundary of the rotatable angle based on determining in the first determination operation that the connection member, which has the second side determined as deviating from the rotatable angle by which the second side is rotatable about the first side, deviates from the lower boundary of two opposite boundaries in the upward/downward direction of the rotatable angle.

12. The method of claim 9, wherein the body part posture adjustment operation comprises inclining the body part to adjust the height of the body part while inclining the body part so that the body part has a selected body angle with respect to the ground surface based on determining in the first determination operation that the connection members of a first set of the eccentric drive parts deviate from an upper boundary of two opposite boundaries in the upward/downward direction of the rotatable angle and the connection members of a second set of the eccentric drive parts deviate from a lower boundary of the two opposite boundaries in the upward/downward direction of the rotatable angle.

13. The method of claim 12, wherein the inclining of the body part adjusts the height of the body part in a state in which the second side of the connection member, which is determined as deviating from the upper boundary in the first determination operation, is positioned on the upper boundary of the rotatable angle and in the state in which the second side of the connection member, which is determined as deviating from the lower boundary in the first determination operation, is positioned on the lower boundary of the rotatable angle based on determining in the first determination operation that the connection members of a first set of the eccentric drive parts deviate from the upper boundary of the two opposite boundaries in the upward/downward direction of the rotatable angle and the connection members of a second set of the eccentric drive parts deviate from the lower boundary of the two opposite boundaries in the upward/downward direction of the rotatable angle.

14. The method of claim 13, wherein the inclining of the body part derives a derived angle defined between the body part and the ground surface from a relationship formula between a first height of the second side of each of the connection members provided in the movable object, a second height of the body part, and the ground angle defined between the body part and the ground surface and inclines the body part while corresponding to the derived angle.

15. The method of claim 14, wherein the inclining of the body part derives the derived angle of the body part with respect to the ground surface from the relationship formula by use of a pseudo inverse.

16. A method of operating a movable object, the method comprising controlling a first connection member and a second connection member, wherein the movable object comprises the first connection member, the second connection member, a first wheel, a second wheel, and a body part, to control a body height of the body part relative to a ground surface and to control a body angle of the body part relative to the ground surface,
wherein a first-connection-member first side of the first connection member is rotatably coupled to the first wheel,
wherein a first-connection-member second side of the first connection member is rotatably coupled to a body-part first side of the body part,
wherein a second-connection-member first side of the second connection member is rotatably coupled to the second wheel,
wherein a second-connection-member second side of the second connection member is rotatably coupled to a body-part second side of the body part, and
wherein the controlling of the first connection member and the second connection member comprises maintaining the first-connection-member second side of the first connection member and the second-connection-member second side of the second connection member to be located between the first-connection-member first side of the first connection member and the second-connection-member first side of the second connection member.

17. The method of claim 16, wherein a first rotatable angle by which the first-connection-member second side of the first connection member is rotatable about the first-connection-member first side of the first connection member is limited to being smaller than 180 degrees.

18. The method of claim 17, wherein a second rotatable angle by which the second-connection-member second side of the second connection member is rotatable about the second-connection-member first side of the second connection member is limited to being smaller than 180 degrees.

19. The method of claim 16, wherein the controlling of the first connection member and the second connection member is such that the body angle is minimized.

20. The method of claim 16, wherein the controlling of the first connection member and the second connection member is such that the body angle is maintained at zero.
